(19) United States
(12) Patent Application Publication
(10) Pub. No.: US 2026/0002396 A1
(43) Pub. Date: Jan. 1, 2026

(54) DOOR ASSEMBLIES

(71) Applicant: MORRYDE INTERNATIONAL, INC., Elkhart, IN (US)

(72) Inventors: Christopher Taylor, Elkhart, IN (US); Benjamin Yoder, Middlebury, IN (US)

(21) Appl. No.: 19/248,723

(22) Filed: Jun. 25, 2025

Related U.S. Application Data
(60) Provisional application No. 63/664,458, filed on Jun. 26, 2024.

(51) Int. Cl. E05F 5/00; E05D 15/06

(52) U.S. Cl. CPC E05F 5/003; E05D 15/063; E05Y 2201/22; E05Y 2201/224; E05Y 2201/684; E05Y 2900/512

(57) ABSTRACT

Door assemblies are described that include a track configured to have one or more roller assemblies of a door coupled thereto, such that the door hangs from and is movable along the track via the roller assemblies. The track defines one or more stops including contoured portions therein to receive a portion of one of the roller assemblies therein. The door assemblies can include the door and one or more roller assemblies movably coupling the door to the track.

### CROSS-REFERENCE TO RELATED APPLICATION

This application claims the priority benefit of U.S. Provisional Application No. 63/664,458, filed Jun. 26, 2024, which is hereby incorporated by reference herein in its entirety.

### FIELD OF THE DISCLOSURE

The present disclosure generally relates to door assemblies.

### BACKGROUND

With conventional barn door tracks, the track is mounted to a wall or ceiling above a door opening and brackets with rollers are attached to the barn door to allow the door to glide along the track. If the track is mounted slightly out of level or if the barn door track is mounted in a moving vehicle, such as a recreational vehicle (RV), or if the door is shoved rapidly, it can be difficult to keep the door in the open or closed position. In order to maintain proper position of the door in the aforementioned instances, a locking mechanism would typically be applied to the door and to the wall or possibly the barn door track to hold the door in position.

### BRIEF DESCRIPTION OF THE DRAWINGS

FIG. 1 is a front elevational view of a door assembly including a door, a track, and roller assemblies in accordance with the teachings of the present disclosure.

FIG. 2 is a front elevational view of the track for the door assembly of FIG. 1 including a detail section 4.

FIG. 3 is a perspective view of the track of FIG. 2 including a detail section 5.

FIG. 4 is a sectional view of the track of FIG. 2 within detail section 4.

FIG. 5 is a sectional view of the track of FIG. 3 within detail section 5.

FIG. 6 is a sectional perspective view of the door assembly of FIG. 1 showing a first example locking mechanism in a first position.

FIG. 7 is a sectional perspective view of the door assembly of FIG. 6 showing the locking mechanism in a second position.

FIG. 8 is a sectional perspective view of the door assembly of FIG. 1 showing a second example locking mechanism in a first position.

FIG. 9 is a sectional perspective view of the door assembly of FIG. 8 showing the locking mechanism in a second position.

FIG. 10 is a rear sectional perspective view of the door assembly of FIG. 8.

### DETAILED DESCRIPTION

Door assemblies and vehicles having door assemblies are described. The door assemblies include tracks having one or more contoured or notched portions to catch and hold a barn door-type door in a desired position. The contoured or notched portions have a concave shape to receive a roller, axle, or other portion of the door therein when slid across the track.

Barn-type door assemblies as described herein include one or more roller assemblies, such as two as shown, having wheels and axles. The roller assemblies extend above the door and are mounted to move along the track with the door hanging below the track. The roller assemblies are movable along the track to move the door from one end of the track to the other end of the track, which can be used, for example, to expose or conceal an entryway, room, compartment, and so forth.

In the examples provided herein, the track includes contours at opposite ends to capture a portion of one or the roller assemblies of the door and positively hold the roller assembly of the door, so that the door can be maintained in a desired position (e.g., the open and/or closed positions). Although two contours are shown in the illustrated examples, a barn door track as described herein could be made with one or more of these contours to hold the position of the door in any of numerous positions, including an open position, one or more intermediate positions, and/or a closed position.

Advantageously, the contour of the track keeps the door from moving when the track is slightly out of level and may be configured to keep the door from sliding back and forth when installed in a vehicle. This configuration may also keep the door from bouncing off an end stop of the track if shoved rapidly or forcefully. This allows a standard non-locking door to have a similar effect of a locking door.

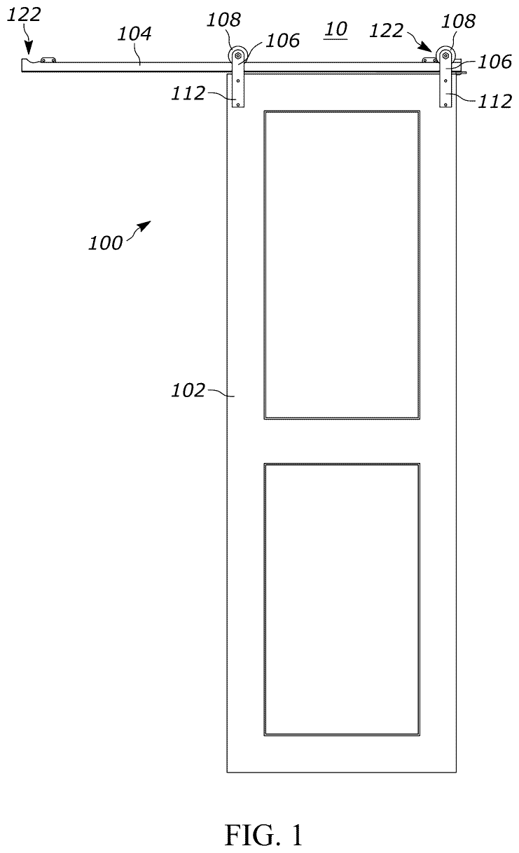

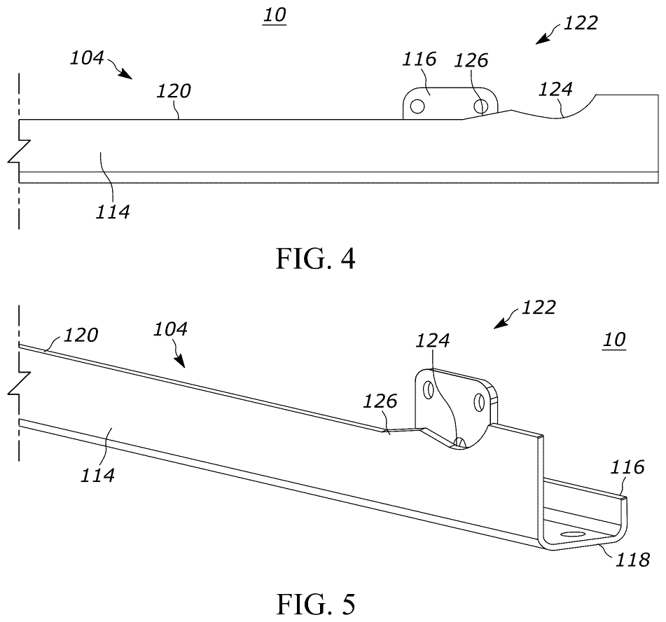

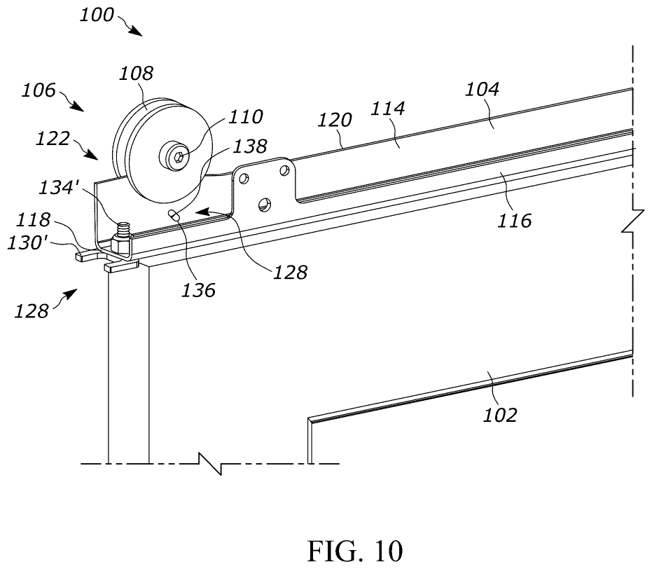

Details of example door assemblies 100 are shown in FIGS. 1-10. The door assemblies 100 include a door 102, a track 104, and one or more roller assemblies 106 coupled to the door 102 and movable along the track 104. The door 102 can have any suitable configuration and be made from any suitable material. For example, the door 102 can have a solid cross-section, can include inserts, such as glass, plastic, or other paneling, and so forth. The door assemblies 100 are adapted for use in vehicles. For example, the door assemblies 100 can be configured to hold the door 102 in a desired position while the vehicle travels, stops, and starts. The vehicles as described herein can be a “recreational vehicle” or “RV” which includes toy haulers, travel trailers, fifth wheels, goosenecks, motor homes, campers, and so forth. The vehicle can also be a utility trailer or utility vehicle. The vehicle can be a towable trailer or a motorized unit.

In some examples, the roller assemblies 106 include one or more rollers or wheels 108 adapted to roll along the track 104 about an axle 110 and a bracket 112 to couple the roller assemblies 106 to the door 102. In other examples, the roller assemblies 106 can include sliding members that slide along the track rather than roll.

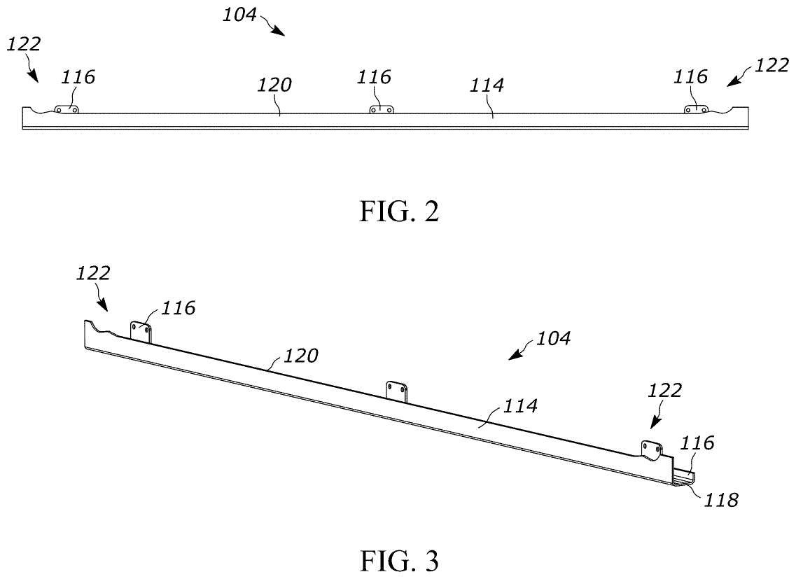

As shown in FIGS. 2 and 3, the track 104 includes a front wall 114, a rear wall 116, and a bottom wall 118 extending between the front and rear walls 114, 116. The rear wall 116 is configured to be mounted to a wall or other substrate of a vehicle, such as via brackets of the wall as shown and fasteners. In an alternative example, the track 104 can be configured to mount to a ceiling of the vehicle, such as with a top wall/flange secured to the ceiling with fasteners or the like. The rollers 108 of the roller assemblies 106 are configured to move along a top edge 120 of the front wall 114. The top edge 120 defines stops 122 corresponding to positions that the door 102 can be stopped and held in. For example, the stops 122 can be disposed at ends of the track 104, which can correspond to open and closed positions for the door 102. Additional intermediate stops 122 can be provided for additional door positions, if desired. In alternative examples, the top edge 120 can include one or more flanges for additional contact with the roller 108 or the rollers 108 can move along a channel or groove defined by walls of the track 104.

The stops 122 include contoured portions 124 (e.g., a generally concave configuration) to capture the roller 108 of one of the roller assemblies 106 therein and positively hold the roller 108, so that the door 102 can be maintained in a desired position (e.g., an open and/or closed position). Further, in some examples, the stops 122 can include an inclined portion 126 adjacent to the contoured portion 124 to establish an increased depth for the contoured portion 124 while maintaining a hanging height for the door 102 while received within the contoured portion 124 relative to a hanging height of the door 102 while on other portions of the track 104 (e.g., portions of the track 104 extending between the stops 122). If the contoured portion 124 is in an intermediate position along the track 104, both sides of the contoured portion 124 can have an associated inclined portion 126. Additionally, if the contoured portion 124 is disposed at an end of the track 104, the portion of the contoured portion 124 adjacent to the end of the track 104 may have an increased end height to assist in stopping movement of the door 102 towards the end of the track 104.

In some examples, a more positive lock may be helpful, whether for safety of the user or for travel. In these examples, the door assembly 100 can include a locking mechanism 128 that includes a lock member 130, 130′ (e.g., a plate, bracket, rod, etc.) that is movable to engage the door 102/roller assembly 106 and track 104 to prevent or restrict relative movement therebetween. The door assembly 100 can include a locking mechanism 128 for each stop 122 of the track 104 or for fewer than all of the stops 122.

In some examples, the locking member 130, 130′ can be moved between a first position spaced from the gap between the top of the door 102 and bottom of the track 104 and a second position disposed at least partially within the gap. In the second position, the roller 108 is unable to navigate out of the contoured portion 124 of the track 104 (e.g., moved upwardly over the raised edge of the contoured portion 124), such that the door 102 is held in place relative to the track 104.

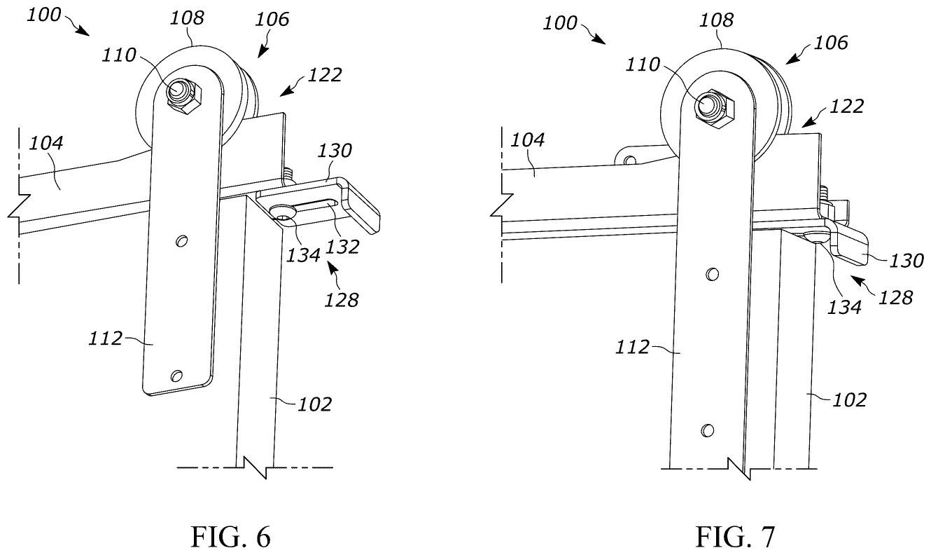

In the example of FIGS. 6 and 7, the lock member 130 can slide relative to the door 102 and track 104. As shown, the lock member 130 can define a slot opening 132 and be secured to the track 104, door 102, or other structure of the vehicle by a fastener 134. When locking is desired, the lock member 130 can have a friction fit, such that a user can slide the lock member 130 over the force of friction into the gap between the door 102 and track 104, such as with a lock nut. In another example, a user can loosen the fastener 134, slide the lock member 130 into the gap between the door 102 and track 104, and retighten the fastener 134. Alternatively, the lock member 130 can have a tongue-and-groove connection, a snap fit connection, a press fit connection, and so forth. Pursuant to this, in some examples, the locking mechanism 128 can be utilized without the fastener 134, such that a user inserts the separate lock member 130 into the gap and removes the lock member 130 from the assembly 100 when movement of the door 102 is desired. In some examples, the lock member 130 can include a gripping flange as shown to allow a user to more easily move the lock member 130 between the first and second positions.

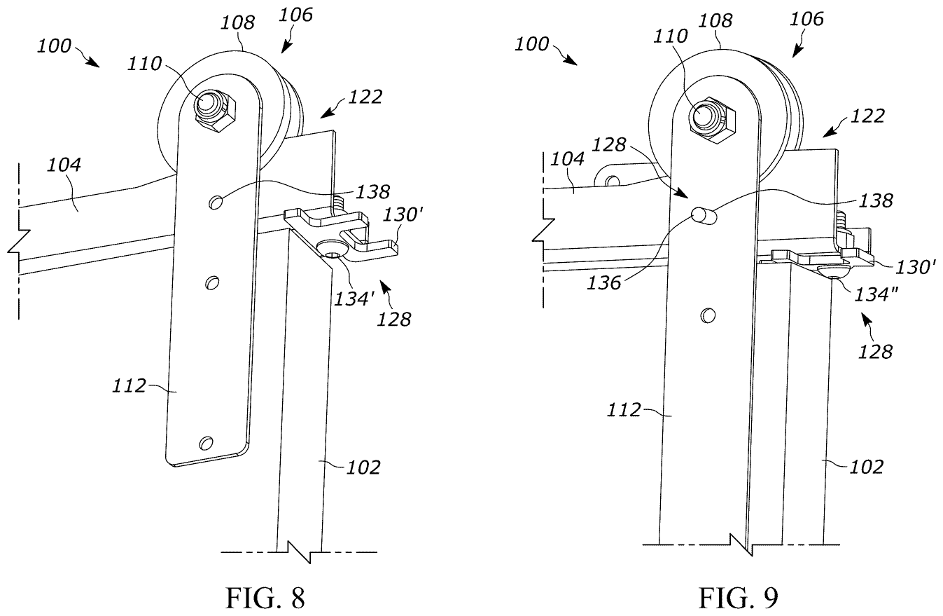

In one of the examples of FIGS. 8-10, the lock member 130′ of the locking mechanism 128 can pivot relative to the door 102 and track 104. As shown, the lock member 130′ is pivotably coupled relative to the door 102 and track 104 (e.g., to the door 102, to the track 104, and/or to adjacent structure of the vehicle) to be movable between the first position spaced from the gap between the door 102 and track 104 and the second position disposed at least partially within the gap. As shown, the lock member 130′ is secured to the track 104, door 102, or other structure of the vehicle by a fastener 134′. When locking is desired, the lock member 130′ can have a friction fit, such that a user can pivot the lock member 130 over the force of friction into the gap between the door 102 and track 104, such as with a lock nut. In another example, a user can loosen the fastener 134′, pivot the lock member 130 into the gap between the door 102 and track 104, and retighten the fastener 134′. In some examples, the lock member 130′ has a pronged configuration with two prongs extending in a first direction and a third prong extending in a second direction, transverse to the first direction. With this configuration, the inner prong of the two prong configuration can be pivoted into and out of the gap between the door 102 and track 104 for locking/unlocking. The other prongs, which form an angle therebetween, such as generally perpendicular as shown, can provide a user two different grips for pivoting the lock member 130′ depending on the position of the lock member 130′ and the user.

In another example shown in FIG. 8-10, a pin, block, or other lock member 136 can be placed through aligned openings 138 in the mounting bracket 112 of the roller assembly 106 and the track 104. The lock member 136 can include a retention mechanism, such as a cotter pin or clip to ensure that the lock member 136 is not inadvertently removed from the aligned openings 138.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples without departing from the scope of the claims.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A door assembly comprising:
a track configured to have one or more roller assemblies of a door coupled thereto, such that the door hangs from and is movable along the track via the roller assemblies, the track defining one or more stops including contoured portions therein to receive a portion of one of the roller assemblies therein.

2. The door assembly of claim 1, wherein the track comprises two stops adjacent to opposite ends of the track.

3. The door assembly of claim 1, wherein each stop of the track includes an inclined portion adjacent to the contoured portion, such that a hanging height of the door within the contoured portion and along other portions of the track is substantially equal.

4. The door assembly of claim 1, wherein each stop disposed adjacent to an end of the track has an Increased end height to assist in stopping movement of the door towards the end of the track.

5. The door assembly of claim 1, further comprising:
the door; and
two or more roller assemblies coupled to the door.

6. The door assembly of claim 5, wherein each roller assembly comprises a roller movable about an axis and a bracket secured between the roller and the door.

7. The door assembly of claim 6, wherein the track comprises a front wall, a top edge of the front wall defining the one or more stops, and the rollers of the roller assemblies move along the top edge of the front wall.

8. The door assembly of claim 1, further comprising a locking mechanism configured to engage at least one of the door or the track to hold the door in position relative to the contoured portion of one of the one or more stops.

9. The door assembly of claim 8, wherein the locking mechanism includes a lock member slidable into a gap between the track and the door.

10. The door assembly of claim 8, wherein the locking mechanism includes a lock member pivotable into a gap between the track and the door.

11. The door assembly of claim 8, wherein the locking mechanism includes a lock member configured to be inserted into aligned openings of the roller assembly and the track to stop relative movement therebetween.

12. The door assembly of claim 8, further comprising one locking member for each stop of the track.

13. A vehicle including the door assembly of claim 1.

14. The vehicle of claim 13 comprising a recreational vehicle.
